(19) United States
(12) Patent Application Publication
(10) Pub. No.: US 2019/0156971 A1
(43) Pub. Date: May 23, 2019

(54) CONDUCTIVE TRACE GEOMETRY FOR HIGH STRETCH APPLICATIONS

(71) Applicant: Applied Cavitation, Inc, Goleta, CA (US)

(72) Inventors: Damon Brink, Ojai, CA (US); Andrew Bambach, Lompoc, CA (US)

(21) Appl. No.: 16/189,789

(22) Filed: Nov. 13, 2018

Related U.S. Application Data
(60) Provisional application No. 62/588,335, filed on Nov. 18, 2017.

(51) Int. Cl. H01B 7/04; H01B 1/22; H01B 1/24; H01B 3/30; H01B 3/28; H01B 3/46; H01B 3/50

(52) U.S. Cl. CPC H01B 7/04; H01B 1/22; H01B 1/24; H01B 3/50; H01B 3/28; H01B 3/46; H01B 3/302

(57) ABSTRACT

A conductive trace residing on a stretchable medium, whose geometry in terms of one or more of width, thickness, material stack-up, and other properties are varied along the trace to reduce changes in trace resistance when the medium is stretched. In some embodiments, the geometry is arranged to encourage increased bending in selected regions of the trace to allow stretch deformation of the trace at least partially by elongation rather than entirely by dimensional deformation, thereby reducing conductivity change due to changes in cross-sectional area.

This Applications claims the benefit of priority to U.S. Provisional Application, Ser. No. 62/588,335, filed Nov. 18, 2017, incorporated by reference in it's entirety.

### BACKGROUND

The specification relates to conductive traces suitable for applications where the trace resides on a medium subject to stretching and other deformations, such as circuitry printed onto fabrics including clothing and the like.

Advances in the materials used to create electronic circuitry have led to the possibility of incorporating electronic circuits onto and as part of stretchable media, such as fabrics, including the possibility of integrating electronic, computing and display functionality onto new classes of items such as clothing. Conductors exposed to deformations due to stretching exhibit behavior not seen in traditional rigid electronic substrate media. New design approaches for stretchable circuit media applications are desirable.

### BRIEF DESCRIPTION

Example embodiments described herein have innovative features, no single one of which is indispensable or solely responsible for their desirable attributes. Without limiting the scope of the claims, some of the advantageous features will now be summarized.

In some embodiments, a conductive trace residing on a stretchable medium may be provided, whose geometry in terms of one or more of width, thickness, material stack-up, and other properties are varied along the trace to reduce changes in trace resistance when the medium is stretched. In some embodiments, the geometry is arranged to encourage increased bending in selected regions of the trace to allow stretch deformation of the trace at least partially by elongation rather than entirely by dimensional deformation, thereby reducing conductivity change due to changes in cross-sectional area.

A stretchable conductive trace may be provided, including; a first stretchable substrate; and, a second substrate including a stretchable conductive material; wherein the trace modulus may be varied along the trace geometry to increase bending in lower modulus regions relative to higher modulus regions when the first substrate is stretched.

In one embodiment, the trace may further include at least one encapsulant material disposed to encapsulate at least part of the conductive portion of the conductive trace. In another embodiment, the first stretchable substrate may include one or more of a polymer including thermoplastic urethane (TPU), rubber, silicone, or other elastomeric film or a fabric including cotton or synthetic blends including spandex. In one embodiment, the stretchable conductive material may include a polymer filled with a conductive phase, including conductive silver, copper, graphite, graphene, and carbon black.

In another embodiment, wherein the polymer may include a material that exhibits high strain to failure, including thermoplastic urethanes, thermoplastic elastomers, rubber thermosets, silicones, and other materials. In one embodiment, the encapsulant material may include TPU, thermoplastic elastomers, thermoset rubbers, silicones, and other elastomeric materials. In another embodiment, trace modulus variations may include varying width of at least one substrate, varying thickness of at least one substrate at a given width, or filling areas of at least one substrate with different materials, volume fractions of the same material, and mixes of materials and volume fractions to obtain a composite with different moduli including filling with particles including boron nitride and alumina, including being coated with a conductive material.

In one embodiment, trace modulus variations may include varying width of at least one substrate or encapsulant, varying thickness of at least one substrate or encapsulant at a given width, or filling areas of at least one substrate or encapsulant with different materials with different moduli include filling with particles including boron nitride and alumina. In another embodiment, bending geometries may include portions of the conductive trace that are substantially parallel to the main stretch direction, portions of the conductive trace that are substantially orthogonal to the main stretch direction, and portions that transition between these regions, wherein the areas that are substantially parallel to the main stretch direction may have higher modulus than the areas that are substantially orthogonal to the main stretch direction.

In one embodiment, trace geometries may include sinusoidal patterns, square patterns, and omega patterns. In another embodiment, the modulus of the first substrate may be smaller than the modulus of the second conductive substrate. In one embodiment, the modulus ratio of the two substrates may be at least one of greater than 2, 5 or 10. In another embodiment, the ratio of the modulus between the substantially parallel and substantially orthogonal portions of at least one of the substrate layers or encapsulant layers may vary at least one of between 1 and 4 or is greater than 4. In another embodiment, the ratio between the substantially parallel and substantially orthogonal portions of at least one of the width or thickness of at least one of the substrate layers may vary at least one of between 1 and 4 or is greater than 4.

In one embodiment, wherein the ratio between the substantially parallel and substantially orthogonal portions of at least one of the width or thickness of at least one of the substrate layers or encapsulant layers may be at least one of between 1 and 4 or is greater than 4. In another embodiment, for two traces running in parallel, the trace geometry of the two parallel traces may be mirror images of each other. In another embodiment, for three or more traces running in parallel, the trace geometry of adjacent traces may be mirror images of each other.

In one embodiment, a second conductive trace may be stacked on top of the first separated by a dielectric material including an encapsulant, TPU, or other elastomeric material that is not electrically conductive. In another embodiment, two or more conductive traces may be on top of the first each separated by a dielectric material including an encapsulant, TPU, or other elastomeric material that is not electrically conductive. In another embodiment, stiffening extensions of material may be included near the end of the trace wherein the stretch and bending behavior on a first portion of the trace adjacent the trace end may be matched to subsequent portions of the trace. In one embodiment, the first and second substrates may be mounted to a third substrate including fabrics.

### BRIEF DESCRIPTION OF THE DRAWINGS

Aspects and advantages of the embodiments provided herein are described with reference to the following detailed description in conjunction with the accompanying drawings. Throughout the drawings, reference numbers may be re-used to indicate correspondence between referenced elements. The drawings are provided to illustrate example embodiments described herein and are not intended to limit the scope of the disclosure.

FIG. 1 illustrates an example embodiment of a stretchable conductive trace.

FIG. 2 illustrates another example embodiment of a stretchable conductive trace.

FIG. 3 illustrates an example implementation of harmonizing the behavior of a termination end of a trace with the rest of the trace.

FIG. 4 illustrates another example embodiment of a stretchable conductive trace.

FIG. 5 illustrates an example stack-up of various layers in a stretchable trace.

FIG. 6 illustrates an example of a trace, plus other circuitry printed onto an article of clothing.

### DETAILED DESCRIPTION OF ILLUSTRATIVE EMBODIMENTS

Generally, the embodiments described herein are directed toward various approaches to geometry and material selection applied to conductive traces intended for application to stretchable materials such as fabrics and polymers. The conductive traces may form parts of electrical circuits that reside on stretchable media, and therefore need to maintain a level of consistency of performance even when the media on which they are printed or otherwise deposited deform. An example would be a circuit fabricated on a stretchable article of clothing, such as a heater, light display, fitness monitor or other device on material such as spandex. The conductive traces may carry data, power, or other electrical signals from attached devices. It will be appreciated that conductive traces on such a stretchable clothing item may be subjected to significant dimensional deformation, i.e. changes in width, length, and thickness, when the article of clothing is put on, taken off or during use. This example is illustrative of a variety of circuit trace dimensional deformation situations as stretchable media as a host environment for integrated electronics becomes more common.

The current disclosure addresses the issue that deformation of a conductive trace may change the shape of the trace, i.e. its dimensions, and accordingly may affect the area, volume, and or cross-sectional area of the trace, which may affect the conductivity and therefore the resistance of the trace. Large resistance changes may not be tolerable for many circuit designs. Therefore it may be desirable to vary the physical make-up of a trace along it length to manage dimensional deformation to reduce the change in resistance during stretch of the host media.

General elements of conductive traces applied to stretchable media may include a non rigid printable conductive portion, such as conductive inks, and optional elements such as one or more substrate layers.

Generally stretchable traces with reduced resistance change may have the following characteristics:

The trace should conduct electricity, and may include one or more first substrate (fabric or polymer), at least one printable with a conductive material. One example is an elastomeric polymer substrate printed with a conductive ink. An encapsulant material is optional, example encapsulants could be TPU or another printed material.

The trace modulus may vary along the trace geometry. Example modulus variations include:
By wider trace and/or wider substrate and overglaze.
By making portions thicker at a given width.
By filling substrate and/or overglaze with different amounts of material or different material with different moduli in different area. This would include filling with particles such as boron nitride and alumina.

The trace geometry may be configured to allow bending to occur to accommodate overall strain. Overall strain refers to the displacement of the trace terminations or portions of the trace relative to other portions of the trace. Example bending geometries include sinusoidal patterns, square patterns, and omega patterns. For bending to be most effective, the modulus differences outlined below are appropriate:
Initial modulus difference between fabric alone and the conductive trace stackup.
Initial modulus difference between fabric/elastomeric substrate and rest of trace stackup. (In this scenario, part of the printable substrate, e.g. TPU. layer would not need to be cut out.)

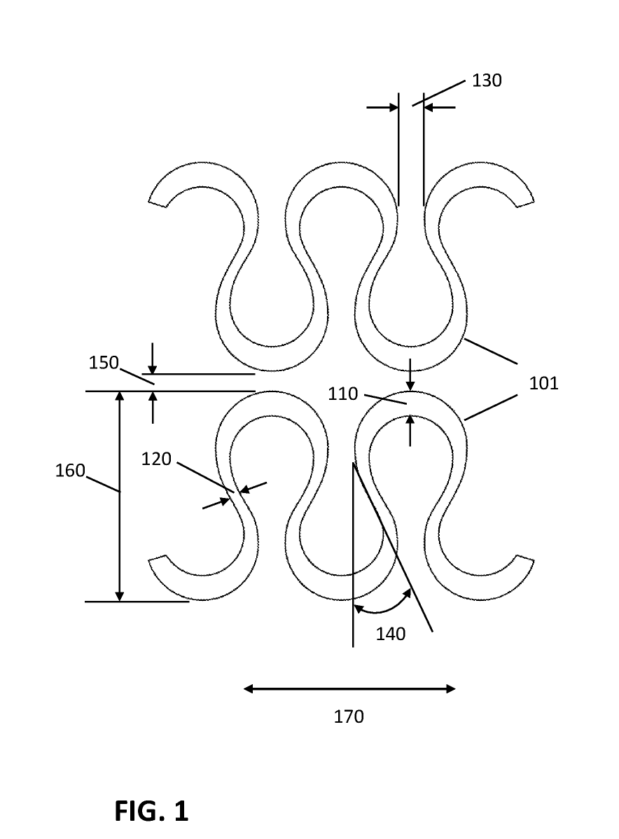

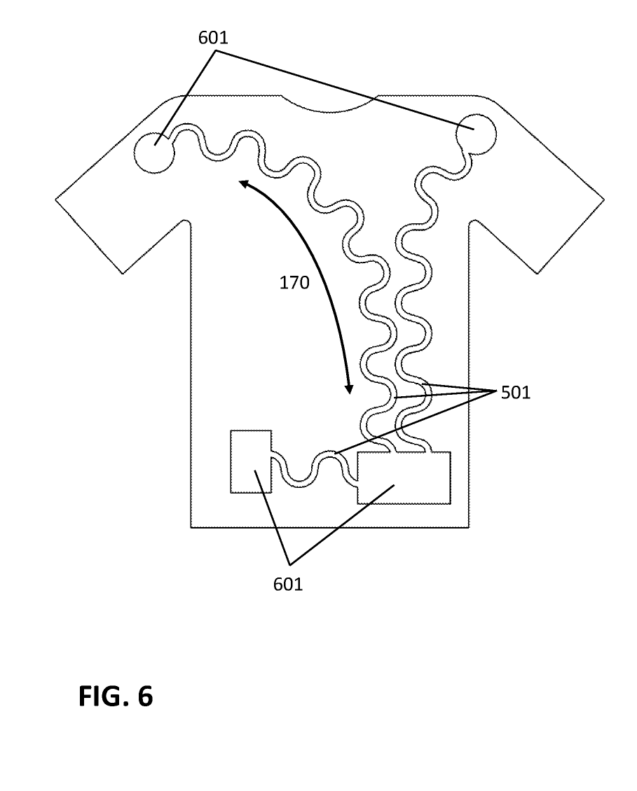

To allow bending, there may be portions of the conductive trace that are substantially parallel to the main stretch direction, portions of the conductive trace that are substantially orthogonal to the main stretch direction, and portions that transition between these regions. An example of a conductive trace is shown in FIG. 1, which is referred to as an omega pattern. Note that there are regions (110) that are substantially parallel to the main stretch direction (170) and regions (120) that are substantially orthogonal to the main stretch direction. In FIG. 1, the angle (140) shows the departure from orthogonality to the main stretch direction of region 120. Thus, we define substantially parallel to the main stretch direction as 170 +/−140, and substantially orthogonal to the main stretch direction as +/−140 from a right angle to 170. (Note that 170 and 140 refer to features in FIG. 1, not specific angles.) The areas that are substantially parallel to the main stretch direction should have higher modulus than the areas that are substantially orthogonal to the main stretch direction. Note that the main stretch direction can curve around a garment, depending on garment design and use, so that the conductive trace pattern can also curve around a garment and is not necessarily straight. One configuration of a curved trace is demonstrated in FIG. 6 (170), wherein the trace connects different components of a wearable electronic system.

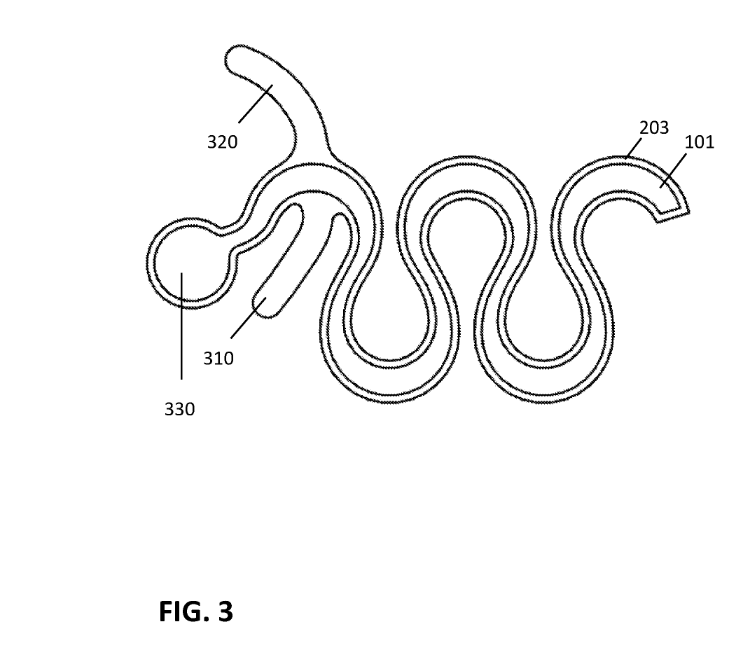

The start of a particular conductive trace pattern can have higher stress and strain concentrations. These stress and strain concentrations can be mitigated by the inclusion of a protrusion of high modulus material, which may be polymeric substrate, encapsulant, terminated conductive trace, or a combination thereof, to shield the main conductive trace. An example of this is shown in FIG. 3, where the protrusions (310, 320) limit the stress and strain concentrations on the first full portion of the curved trace. Different lengths, geometries, and materials can be used to create the protrusions and mitigate the strain concentrations on the first full portion of the curved trace.

Often, more than one conductive trace is required for a particular functional design. For instance, in garments where multiple sensors are deployed, each will require at least one conductive connection. In the case where multiple conductive traces are used, the traces must be stacked appropriately so that bending of the trace portions is not hampered. One way to do this is to create the second trace geometry so that it is a mirror image of the first the trace across the main stretch direction. An example of this is shown in FIG. 1, in which the conductive trace (101) of one portion is a mirror image of the other and separated by a gap (150). Note that the main stretch direction and macroscopic stretch have the same meaning. In this way, the higher modulus areas in both traces that are substantially parallel to the main stretch direction are in close proximity and do not preclude stretching of the gap (130) as shown in FIG. 1. Many traces can be stacked in a mirror image.

The conductive material, e.g. conductive ink itself, could be stretchable. In general the trace may be part of an electrical circuit, connecting a variety of passive or active electronic components.

For most applications, the minimum number of layers is two: a stretchable substrate and the conductive trace. The stretchable substrate could be a polymer (ex: TPU—thermoplastic urethane, rubber, silicone, other elastomeric films) or a fabric (cotton or synthetic blend such as spandex.) Note that in the case of the fabric, the “stretchability” may depend on the weave pattern.

The conductive trace may also be a polymer filled with a conductive phase. The polymer may include a material that can handle high strain without fracture—high strain to failure. Examples are thermoplastic urethanes, rubber thermosets, silicones, and similar materials.

Requirements depend on the use case. A good general range of strain in one direction is 5 to 30% for use. For some extreme applications the strain can reach 100% (double in length). The strain seen during donning and doffing a garment onto which these materials are placed can be much greater—50 to 200%. The stretchable substrate and conductive trace desirably would be able to elongate to accommodate the design strain.

The compliance of the stretchable substrate should be greater than the conductive trace, so that, during system displacement, the stretchable substrate stretches to accommodate a majority of the displacement and the ink stretches minimally. Indeed, the main purpose of the geometry is to reduce strain in the trace for a given overall macroscopic stretch. This is accomplished by inducing bending along trace sections that are within theta plus a buffer (FIG. 1, 140), of orthogonal to stretch direction. This is what we refer to as substantially orthogonal to the main stretch direction. Note that the ink may be adhered to the stretchable substrate. If so, the fabric/ink combination should be 2× or more the modulus of the stretchable substrate alone. (modulus of both materials will increase with stretch.) Good performance is achieved when the modulus ratios exceed 5, and superior performance when the modulus ratio exceeds 10. There is no upper limit on the modulus ratio. Performance may be measured by the change in resistivity as the system is stretched. Lower changes in resistivity are desirable.

For some applications, there may be a layer of fabric, a layer of elastomeric substrate, a layer of conductive trace, and a layer of encapsulant material. In some cases two or three layers of the encapsulant material may be included to ensure protection during the wash cycle. In some cases, there may be multiple layers of elastomeric substrate, especially if the elastomeric substrate is screen printed. There could also be multiple layers of fabric. Fabric may for some embodiments be used to sandwich both sides of the rest of the material. Also, in some cases, an elastomeric film such as that used for the substrate, may also be used as an encapsulant material. In other words, the extruded materials which are used for an elastomeric substrate can also be used as an encapsulant to protect the conductive material.

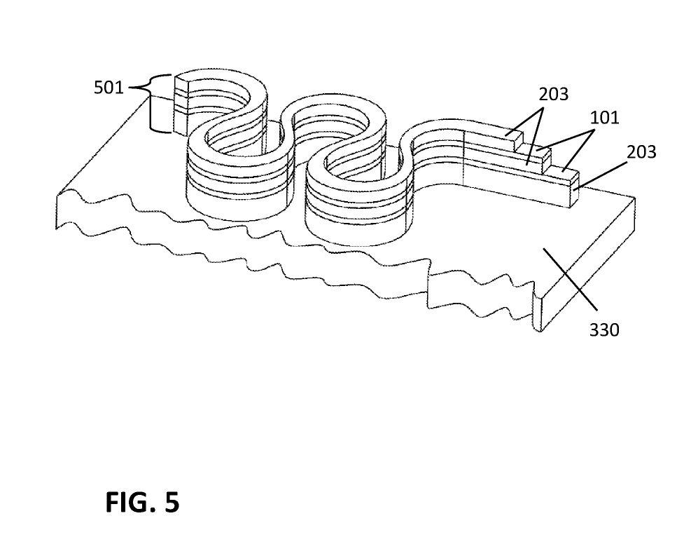

In the scenario where multiple layers are included, the stiffness of the stacked system should be greater than that of the base fabric. An example of this configuration is shown in FIG. 5, wherein 501 delineates the stacked system (ink stack) and 330 is the base fabric. As with a simple two layer system, the modulus ratio performance criteria are the same.

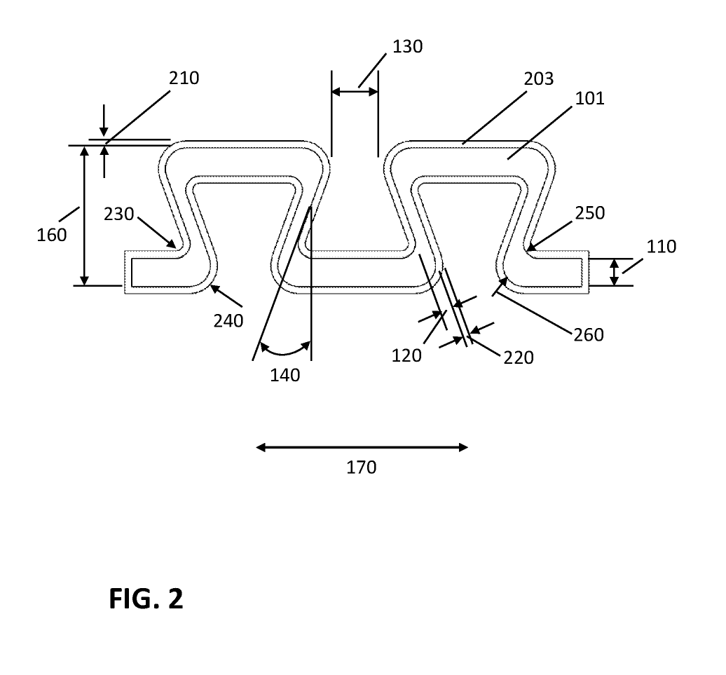

The encapsulant material is an additional material not described in the two layer case. The encapsulant is shown in FIG. 2 (203). As with the other materials in the system, it should stretch to accommodate deformation of the underlying fabric. It need not be not conductive. It's purpose is to protect the conductive trace from washing, abrasion, and debris/sweat encountered during use. The encapsulant layer may be wider than the conductive trace. The overlap of the encapsulant beyond the conductive layer may vary. Increasing the overlap (ie the width) of the encapsulant layer is one method of adjusting the modulus in different regions of the trace. Regions of overlap beyond the conductive layer are shown in FIG. 2 (210, 220).

The encapsulant may include materials such as TPU, thermoplastic elastomers, thermoset rubbers, silicones, and other elastomeric materials. It can also be filled with rigid particles to increase the modulus. Different encapulant materials can be layered on top of each other. For instance, a filled encapsulant, which can be much stiffer, can be deposited over a non-filled encapsulant. It can also be deposited in prescribed areas, to increase the modulus of the total encapsulant layer in specific areas.

In some cases, the elastomeric substrate material can be screen printed or otherwise deposited onto or transferred to a garment. Some embodiments benefit from substrate material filled with particles to increase the modulus of the substrate materials. These filled materials can be selectively deposited so that the modulus can be increased in prescribed areas. In this way, the bending of the conductive trace can be enhanced and the overall performance of the system can be improved. For many cases, this means that the increase in resistance of the conductive system is reduced as the system stretches.

### SPECIFIC EXAMPLES

1. Layup 1
a. Fabric. 20% Spandex Blend. 0.020″ thick.
b. TPU seam seal tape. Bilayer material wherein a lower MW TPU melts into fabric during heat pressing to adhere. This adhesive layer is in contact with the fabric. 0.005″ thick total. This layer is cut into “omega” pattern see FIG. 1. This is incrementally wider than the trace width.
c. Conductive stretchable trace. Typically 10 microns (0.0004″) thick. Printed into omega pattern.
d. Encapsulant layer 1. Polymer only, per description above. 10 microns thick. Printed into omega pattern—incrementally wider than the conductive trace.
e. Encapsulant layer 2. Polymer only, per above. Repeat of d.

2. Layup 2.
a. Fabric. 15% spandex blend. 0.015″ thick. (Note—everything but fabric is the Omega pattern. The conductive ink is a thinner—less wide—version of the Omega.)
b. Printed layer of TPU with low MP to act as adhesive to fabric. 3 microns thick.
c. Printed layer of TPU with higher MP that doesn't melt when exposed to press heat. 15 microns
d. Printed layer of TPU with higher MP—two passes with two materials in two different locations to make one full layer—15 microns thick
   i. Portions of layer that are in the direction of pull are filled with hexagonal boron nitride at 20 vol % to increase stiffness
   ii. Portions of layer that are orthogonal to the direction of pull are polymer only.
e. Printed layer of TPU with higher MP onto which the conductive ink is printed. 15 microns thick.
f. Conductive stretchable trace. Typically 10 microns (0.0004″) thick. Printed into omega pattern.
g. Printed layer of TPU with higher MP. 15 microns thick.
h. Printed layer of TPU with higher MP—two passes with two materials in two different locations to make one full layer—15 microns thick
   i. Portions of layer that are in the direction of pull are filled with hexagonal boron nitride at 20 vol % to increase stiffness
   ii. Portions of layer that are orthogonal to the direction of pull are polymer only.
i. Printed layer of TPU with higher MP that doesn't melt when exposed to press heat. 15 microns
j. Printed layer of TPU with low MP to act as adhesive to fabric. 3 microns thick.
k. Fabric. 15% spandex blend. 0.015″ thick. (Note—everything but fabric is the Omega pattern. The conductive ink is a thinner version of the Omega.)

The following details may be read along with FIG. 1. In general, unless other Figures are specifically called out, reference numbers starting with 1 refer to FIG. 1. FIG. 1 describes an “omega” pattern conductive trace, modified to reflect the teachings of the current disclosure. At the top level, the narrower (and/or thinner, lower modulus construction) parts of the pattern substantially orthogonal to the direction of stretch 170 are through tailored profiling of modulus configured to preferentially bend over stretch so their dimensional change is reduced, and the stretching of the wider (and/or thicker, higher modulus construction) regions substantially parallel to the stretch direction will matter less because they are larger are and their resistance change will be proportionally lower, the net result is reduced affect of stretching on resistance. An example parameter set to accomplish these goals follows:
FIG. 1 callout suggested ranges
In general, the polymer substrate and encapsulant materials (FIG. 2, 203) are wider than the conductive trace (101) so as to completely protect the conductive trace.
Width of the conductive trace is characterized by 110 and 120. In most cases, we will add 0.1 mm to 2 mm to 110 and 120 when comparing the width of the 110 and 120 regions of the conductive trace. (Region 110 is substantially parallel to the stretch direction and is typically wider than region 120 which is substantially orthogonal to the stretch direction.)
Ratios
   110/120 can vary from 1 to 4 for most applications.
   110/120 can be greater than 4 for certain applications in which trace geometry is less constrained.
   If ratio is 1, localized material properties enhance performance. Note that 110/120 of the conductive trace (101) can be different than the substrate and encapsulant (FIG. 2 203), in which case 110/120 of the trace can be 1 and 110/120 polymer>1. This is shown in FIG. 2, wherein the overlap of the substrate beyond the conductive portion of the trace differs with location, and is wider in areas substantially parallel to the stretch direction (210) and narrower in areas substantially orthogonal to the stretch direction (220). In this case, and the bending of sections substantially orthogonal to the main stretch direction is still enhanced as the effective stiffness in the main stretch direction is greater than that orthogonal to the main stretch direction. Note that the main stretch direction is sometimes referred to as direction of pull or the macroscopic stretch direction.
   110/150 typically between 0.5 and 5
   160/130 is typically between 2 and 10
   160/150 is typically between 1 and 10
   130/110 is typically 0.5 to 5
   210/220 is typically between 1 and 3
   210/110 is typically between 0 and 1
   220/120 is typically between 0 and 1
Values
   110 can range from 100 microns to 10 mm. (0.004″ to 0.394″)
   140 can range from −30 degrees to +30 degrees.

Now we will describe what happens when stretching a conductive trace constructed according to FIG. 1 with the above parameters. When the conductive trace is stretched, the geometry and/or material composition is such that localized strain in the fabric occurs in the areas between the omega lines. The width of this area is shown in FIG. 1 as 130. This causes the omega lines to stretch apart, decreasing the value of 140 (FIG. 1) and causing the sections orthogonal to the direction of stretch (areas 120) to bend. As this happens, the regions between the traces (130) increase as the modulus in these locations is low relative to the conductive stack (FIG. 5, 501). The areas in the direction of stretch do not stretch because they are stiffer than the fabric.

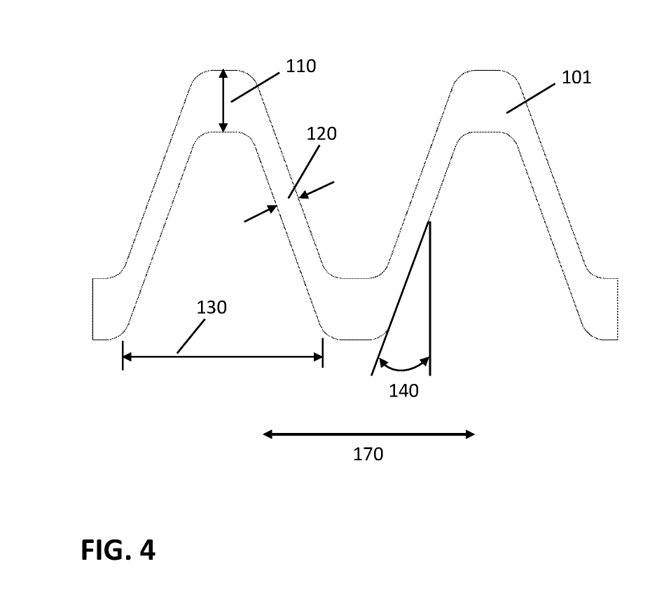

Other conductive trace geometries can offer the same benefits by creating higher modulus sections in the main stretch direction (170) such that bending is enhanced in areas orthogonal to the main stretch direction. Examples are shown in FIG. 2 and FIG. 4. As discussed, these modulus (also known as stiffness) differences can be achieved in different ways. Note also that there is often a gradient in stiffness as the conductive trace transitions in alignment from substantially parallel to the main stretch direction to substantially orthogonal to the main stretch direction. This allows bending to be enhanced without creating strain concentrations at the transition regions. These stiffness gradients can be achieved by grading the trace width or by printing materials with different stiffnesses in the transition region. For trace designs with flat sections, such as FIG. 2 and FIG. 4, there are radii which define the transition between straight sections. These radii may be different between the encapsulant layer and the conductive layer. In FIG. 2, the inner and outer radii of the encapsulant layer are shown as 230 and 240, respectively. In turn, the inner and outer radii of the conductive layer are shown as 250 and 260, respectively. The overall width of the conductive ink stack is represented as 160.

One objective is to get a small increase in resistance as the conductive system is stretched. The conductive system is the entire combination of all materials, which may include the conductive ink, substrate, enapsulant, and fabric materials. Conductive inks increase substantially when stretched. For instance, when conductive inks are stretched repeatedly from 0 to 20%, the resistance can increase between 1.5× to 100× or more. For these geometries of the conductive system, repeated stretching to 20% causes an ink that, in a straight trace would increase 25×, would increase only 2.5× or less. For a single stretch from 0 to 20%, this can be substantially lower and be a mere 5-10% increase in resistance.

When the overall macroscopic stretch (displacement) is accommodated by bending in the conductive trace, the actual material strain in the conductor is reduced and the resistance increase is therefore reduced. Note that theta (FIG. 1, 140) can be designed so that, during stretching, the length of the bend section can decrease and it will go into compression. This is what happens when theta is positive. During continued stretching as section 120 rotates, 140 will become negative and when the theta stretch=negative initial theta, the length in the 120 section is the same and the resistance will be very similar to the initial reading. This is based on a straightforward trigonometric analysis.

In addition, by making 110>120, the contribution to resistance from section 110 will be much less than section 120. This is because the cross sectional area in section 110 is larger than section 120 in this case. In this way, any stretching and concomitant change in resistance in section 110 will be a smaller contribution to the overall resistance increase, thereby reducing the effect of stretching in section 110, if it occurs. (For a constant trace thickness, conductivity will be linearly related to the trace width.) By blending the trace thickness from section 110 to 120, we achieve a good continuous pattern that stretches well and reduces overall resistance change. As mentioned before, when 110>120 in the electrically conductive trace, a higher modulus in the sections substantially parallel to the main stretch direction is obtained which, in turn, encourage bending in the sections of the conductive trace that are substantially orthogonal to the main stretch direction. In these ways, the change in resistance over the length of the conductive trace is reduced as the conductive system is stretched.

A benefit of the trace geometry and material changes (ie-increasing modulus in specific areas) is to enable a macroscopic stretch (or displacement) from one end of the trace to the other while simultaneously reducing the material strain in the conductive material e.g. ink. This is achieved by inducing some areas of the conductive trace geometry to bend and other areas of the conductive trace to translate with reduced deformation in response to the macroscopic stretch. Increasing stiffness in regions that are substantially parallel to the main stretch direction allows the fabric or substrate to stretch in the areas between the conductive trace. This, in turn, causes bending in the regions of the conductive trace that are substantially orthogonal to the main stretch direction. Since bending introduces less strain in the conductive material than direct stretching, the conductivity changes less in these geometries than configurations that allow more stretching in response to the macroscopic stretch.

As discussed above, the conductive trace material will increase in resistance as it is stretched, so reducing strain in the material therefore reduces the increase in resistance. This is a beneficial design feature for wearable electronics applications.

In general, for any non-linear trace geometry, there may be portions of the trace that run parallel to the macroscopic stretch and portions that run perpendicular to the macroscopic stretch. In the Omega Pattern, as depicted in FIG. 1, the areas labeled 110 are substantially parallel to macroscopic stretch and the areas labeled 120 are substantially perpendicular. (Note that an Omega pattern is not needed and that other geometries can achieve the following.) The key elements are as follows:

Increase the effective modulus in some region compared to others, for instance in the 110 regions relative to the 120 regions. This can be done by a) increasing the width of the trace and surrounding substrate, encapsulant, or both, b) increasing the width of the substrate and/or encapsulant but not the conductive trace, c) increasing the thickness of the conductive layer, substrate, and/or encapsulant in region 110 relative to region 120, or d) increasing the material modulus of conductive layer, substrate and/or encapsulant in the 110 region relative to the 120 regions.

Increase the conductivity in the 110 regions relative to the 120 regions. This is done by a) increasing the cross-sectional area of the conductive material in the 110 region; this can be done by printing the material wider in these regions (110>120) or by printing the material thicker in the 110 regions (print twice in the 110 region), or by b) changing the material in the 110 region to a more highly conductive formulation.

Ensuring that the modulus of the 110 regions is substantially greater than the fabric webs between the conductive trace.

110 conductive trace geometry that allows bending in the 120 regions of the trace that are substantially orthogonal to the main stretch direction.

Mechanism

Refer to the Omega pattern in FIG. 1. As the pattern is stretched macroscopically, the gaps (130) will increase as the material in this region (fabric only) configured to be more compliant than the stacked material that contains the conductive trace. In other words, the material in 130 stretches. As 130 increases, the angle theta decreases as the 120 sections are configured to more easily bend and rotate. (Bending and rotating causes substantially less strain in the material than stretching along the axis.) Since the sections in 110 are configured to be stiffer, the strain in these areas is reduced for a given load induced by the macroscopic stretch. Section 120 areas will bend by design.

Since the sections in 110 are for some embodiments wider, they have less resistance than Section 120 areas. (this feature is optional but may be advantageous). Note that even through stretching in 110 is reduced, it will have a finite strain (non-zero). With lower resistance in these areas, the overall resistance is controlled by 120 areas, which do not strain as much as they are bent. This reduces the impact of strain in Section 110 areas on the overall resistance change. Rtotal=Ra+Rb, so if Ra is lower than Rb, a % change in Ra will have a lower influence on % change in Rtotal. (Ra refers to the resistance in the 110 regions, while Rb refers to resistance in the 120 regions.)

Also, in some geometry embodiments like the Omega pattern shown in FIG. 1, theta (140) goes from positive to negative as the macroscopic displacement happens. In this geometry, the material in 120 is actually compressed during the first part of the displacement and then extended to close to an original length in the second portion of the displacement. This reduces the change in resistance in section 120. If an overall design displacement is known, theta can be designed to provide a smaller change in resistance to meet the maximum stretch.

Areas Between 110 and 120

In the omega pattern and other conductive trace geometry configurations, the sections 110 and 120 are connected so that there is a continuous conductive trace to carry an electrical signal. It may be advantageous to have these areas be curved and have a gradient in width (if applicable) to reduce strain and stress concentrations that would be present at sharp transitions.

Multiple Traces

Often it is desirable to conduct more than one electrical signal on more than one trace. In this case, the traces must be arranged relative to one another in a way that does not inhibit the fabric stretching in area 130. This can be done by stacking area 110's in adjacent regions with gap 150, such that the gap 130 can still stretch. If these areas are offset, gap stretching will be deleteriously impacted by the presence of section 110. An example of this configuration is shown in FIG. 1.

In some designs, there will be a need for stretch orthogonal to the main direction of macroscopic stretch. In this case, the line spacing 150 should be increased according to the design and functional requirements. Larger 150 can accommodate more strain in the orthogonal direction.

In some cases, in particular where space is constrained and the overall width of the design envelope is limited to the width of a single trace (160), it is advantageous to stack multiple traces on top of one another 501, as shown in FIG. 5. The number of traces that can be stacked is often ten or less, but can exceed ten. Many applications contain stacks with two conductive traces. Other applications contain stacks with four conductive traces. When the conductive traces are stacked, the conductive portions of the stack are separated by a non-conductive layer that may be an encapsulant or other dielectric materials such as an extruded polymer like TPU. In general, there may be prescribed gaps in the dielectric separation in order to create vias between conductive layer. Moreover, the regions that connect to a component will have a prescribed gap in the dielectric. An example of an area with would not contain encapsulation in FIG. 3, 330. This area is a bond pad which will be electrically connected to a component.

The conductive traces for some applications may be printed onto a full sheet of elastomeric substrate such that the area 130 is filled with substrate polymer. In this case, the extra material (in 130) may be cut out to ensure the underlying fabric will stretch in 130. This can be done by laser cutting, water jet cutting, die cutting, ultrasonic cutting or other means. If the elastomeric substrate is sufficiently compliant or sufficiently thin, then the material may not need to be eliminated.

The non-printed side of the elastomeric substrate may be heat pressed onto the fabric of the garment. This softens the elastomeric substrate and allows the material to bond with the fibers of the fabric.

In some cases, the printed side of the substrate may be heat pressed onto the fabric.

These configurations allow effective data and power transfer, as well as heating applications, as the resistance remains more consistent with stretch than other patterns.

FIG. 2 shows a pattern similar to the Omega pattern but with straight sections in the 110 regions. This increases the distance 130 so that the localized strain in the fabric can be less to accommodate a given macroscopic bend. It also opens 130 to makes it easier to remove substrate material if required. The optimum length of the straight section in 110 will depend on the fabric, elastomeric substrate, encapsulant, and ultimate design requirements. This figure also shows the periphery of the encapsulant and/or substrate (203), which is normally larger than the conductive trace area. The extra amount over the periphery of the conductive trace is 210 and 220. 210 can be larger than 220 to help stiffen area 110. The range in 210 can range from zero to 130.

FIG. 3 shows a finger of encapsulant and/or substrate material that may or may not contain conductive trace. (310 and 320) These features are stiffening extensions and shield the material from additional strain concentrations that would cause excess bending in nearby areas. This is meant to mimic the shielding done by the connected trace geometry in the field.

Many different patterns can be used to accomplish the goals of increasing stiffness in the regions that are substantially parallel to the main stretch direction (170) and therefore inducing bending the regions that are orthogonal to the main stretch direction. Another example is FIG. 4. In this case, rotation in theta will extend the sections in 120 slightly, causing higher changes in resistance. However, the 130 is much larger allowing the fabric to stretch more easily and reduce the contribution of resistance increase in area 110. Moreover, like FIG. 2, excess substrate material is more easily eliminated via laser or die cutting. Ultimately, the final geometry will depend on a number of factors including performance and assembly.

Referring to FIG. 5 the layers of conductive material can be layered to transmit multiple signals in the same material stack. This figure shows one embodiment of this approach, where two conductive traces (101) are separated by dielectric materials (203) and attached to a fabric (330). The system of dielectric and conductive materials is referred to as the ink stack (501). In some cases, the dielectric layers, which can be either TPU or other stretchable encapsulant, can contain an adhesive (not shown) to assist mechanical coupling to the fabric (330) and other layers.

FIG. 6 shows an electric circuit on a garment. In this case, circuit element 601 which include devices such as a battery, a transmitter, processor, and multiple sensors are interconnected by a conductive trace 501. The main stretch direction 170 follows the conductive trace and curves along the garment.

The embodiments described herein are exemplary. Modifications, rearrangements, substitute devices, processes, etc. may be made to these embodiments and still be encompassed within the teachings set forth herein.

1. A stretchable conductive trace, comprising;
a. a first stretchable substrate; and,
b. a second substrate including a stretchable conductive material;
wherein the trace modulus is varied along the trace geometry to increase bending in lower modulus regions relative to higher modulus regions when the first substrate is stretched.

2. The conductive trace of claim 1 further comprising at least one encapsulant material disposed to encapsulate at least part of the conducive portion of the conductive trace.

3. The conductive trace of claim 1 wherein the first stretchable substrate includes one or more of a polymer including thermoplastic urethane (TPU), rubber, silicone, or other elastomeric film or a fabric including cotton or synthetic blends including spandex.

4. The conductive trace of claim 1 wherein the stretchable conductive material includes a polymer filled with a conductive phase, including conductive silver, copper, graphite, graphene, and carbon black.

5. The conductive trace of claim 4 wherein the polymer includes a material that exhibits high strain to failure, including thermoplastic urethanes, thermoplastic elastomers, rubber thermosets, silicones, and other materials.

6. The conductive trace of claim 2 wherein the encapsulant material includes TPU, thermoplastic elastomers, thermoset rubbers, silicones, and other elastomeric materials.

7. The conductive trace of claim 1 wherein trace modulus variations include varying width of at least one substrate, varying thickness of at least one substrate at a given width, or filling areas of at least one substrate with different materials, volume fractions of the same material, and mixes of materials and volume fractions to obtain a composite with different moduli including filling with particles including boron nitride and alumina, including being coated with a conductive material.

8. The conductive trace of claim 2 wherein trace modulus variations include varying width of at least one substrate or encapsulant, varying thickness of at least one substrate or encapsulant at a given width, or filling areas of at least one substrate or encapsulant with different materials with different moduli include filling with particles including boron nitride and alumina.

9. The conductive trace of claim 1 wherein bending geometries include portions of the conductive trace that are substantially parallel to the main stretch direction, portions of the conductive trace that are substantially orthogonal to the main stretch direction, and portions that transition between these regions, wherein the areas that are substantially parallel to the main stretch direction have higher modulus than the areas that are substantially orthogonal to the main stretch direction.

10. The conductive trace of claim 9 wherein trace geometries include sinusoidal patterns, square patterns, and omega patterns.

11. The conductive trace of claim 1 wherein the modulus of the first substrate is smaller than the modulus of the second conductive substrate.

12. The conductive trace of claim 11 wherein the modulus ratio of the two substrates is at least one of greater than 2, 5 or 10.

13. The conductive trace of claim 9 wherein the ratio between the substantially parallel and substantially orthogonal portions of at least one of the width or thickness of at least one of the substrate layers varies at least one of between 1 and 4 or is greater than 4.

14. The conductive trace of claim 2 wherein the ratio between the substantially parallel and substantially orthogonal portions of at least one of the width or thickness of at least one of the substrate layers or encapsulant layers is at least one of between 1 and 4 or is greater than 4.

15. The conductive trace of claim 1 wherein for two traces running in parallel, the trace geometry of the two parallel traces are mirror images of each other.

16. The conductive trace of claim 1 wherein for three or more traces running in parallel, the trace geometry of adjacent traces are mirror images of each other.

17. The conductive trace of claim 1 wherein a second conductive trace is stacked on top of the first separated by a dielectric material including an encapsulant, TPU, or other elastomeric material that is not electrically conductive.

18. The conductive trace of claim 1 wherein two or more conductive traces are on top of the first each separated by a dielectric material including an encapsulant, TPU, or other elastomeric material that is not electrically conductive.

19. The conductive trace of claim 1 wherein stiffening extensions of material are included near the end of the trace wherein the stretch and bending behavior on a first portion of the trace adjacent the trace end is matched to subsequent portions of the trace.

20. The conductive trace of claim 1 wherein the first and second substrates are mounted to a third substrate including fabrics.

21. The conductive trace of claim 8 wherein bending geometries include portions of the conductive trace that are substantially parallel to the main stretch direction, portions of the conductive trace that are substantially orthogonal to the main stretch direction, and portions that transition between these regions, wherein the areas that are substantially parallel to the main stretch direction have higher modulus than the areas that are substantially orthogonal to the main stretch direction.

22. The conductive trace of claim 21 wherein the ratio the ratio of the modulus between the substantially parallel and substantially orthogonal portions of at least one of the substrate layers or encapsulant layers varies at least one of between 1 and 4 or is greater than 4.
